(19) United States
(12) Patent Application Publication
(10) Pub. No.: US 2013/0040115 A1
(43) Pub. Date: Feb. 14, 2013

(54) Laminated Board And Foam Product And Method For Making The Same

(71) Applicant: Tzong In Yeh, Fremont, CA (US)

(72) Inventor: Tzong In Yeh, Fremont, CA (US)

(21) Appl. No.: 13/313,660

(22) Filed: Dec. 7, 2011

(30) Foreign Application Priority Data
Aug. 10, 2011 (TW) 100128450

(51) Int. Cl. B32B 5/18; B32B 27/32; B29C 59/02

(52) U.S. Cl. 428/201; 156/209; 428/318.4; 428/318.6; 428/195.1; 428/213; 428/316.6

(57) ABSTRACT

A foam product comprising a foam core having a first foam layer generally covering one side and a laminated board generally covering at least a portion of the generally opposing side, wherein the laminated board portion comprises a second foam layer, a first plastic film and a second plastic film, and wherein the first foam layer is attached to the top surface of the foam core, and the second foam layer of the laminated board is attached to the bottom surface of the foam core. In a preferred embodiment, the second plastic film is interposed between the second foam layer and the first plastic film by means of extrusion lamination to combine the second foam layer with the first plastic film.

### BACKGROUND OF INVENTION

1. Field of Invention

The present invention relates to a laminated board and more particularly to a laminated board having a plastic film combined with a foaming material by means of extrusion lamination and a method for making the laminated board.

2. Related Prior Art

U.S. Pat. No. 6,988,920 discloses a foam product (e.g. surfboard), having a foam core, and a laminated board attached to the bottom surface of the foam core for protection. The laminated board is mainly constituted by a foam skin, a plastic film with a pattern (patterned film, for short) and a thickened plastic sheet, where the foam skin is combined with the bottom surface of the foam core, the patterned film is sandwiched between the foam skin and the plastic sheet, allowing the product to be eye-appealing and identifiable. Furthermore, the patterned film is heat laminated to the bottom surface of the foam skin, and the plastic film is formed directly on the bottom surface of the pattern film with a definite thickness by means of extrusion lamination so as to provide the product with wear resistance. Therefore, the foam skin, patterned film and plastic sheet are stacked together, and then heat laminated and extrusion laminated in sequence to form the laminated board.

### SUMMARY OF INVENTION

To provide a relatively simpler method for making a cost-down laminated board and a foam product including it, the present invention is proposed.

Specifically, a laminated board of the present invention includes a foam layer, a first plastic film and a second plastic film interposed between the foam layer and the first plastic film by means of extrusion lamination. The process of manufacturing the laminated board includes the steps of preparing the foam layer and the first plastic film with a pattern or color first, extruding the molten second plastic film through an extruder, and then laminating the foam layer, the molten second plastic film, and the first plastic film to have the second plastic film interposed between the foam layer and the first plastic film. The thickness of extruded second plastic film is preferably greater than the thickness of the first plastic film, thereby ensuring that the bonding of the foam layer and the first plastic film is complete and durable.

In addition, a foam product to which the laminated board of the present invention is applied includes not only the aforementioned laminated board, but also a foam core and another foam layer that is combined with the top surface of the foam core. Furthermore, the laminated board is combined with the bottom surface of the foam core through the foam layer thereof.

Comparing with the conventional technology, the present invention of the laminated board is not stacked up layer by layer as the prior art does but formed in a single extrusion laminating step, and therefore the manufacture of the present invention is relatively simpler. Moreover, the foam product to which the laminated board is applied can also be made cheaper and quicker.

### BRIEF DESCRIPTION OF DRAWINGS

The present invention can be more fully understood by reference to the following description and accompanying drawings, in which:

FIG. 1 is a partial cross-sectional view of a laminated board according to a preferred embodiment of the present invention;

FIG. 2 is a cross-sectional schematic view of a manufacturing process of the laminated board;

FIG. 3 is perspective view of a foam product to which the laminated board is applied according to the present invention; and

FIG. 4 is a partial cross-sectional view of the foam product shown in FIG. 3,

### DETAILED DESCRIPTION OF EMBODIMENTS

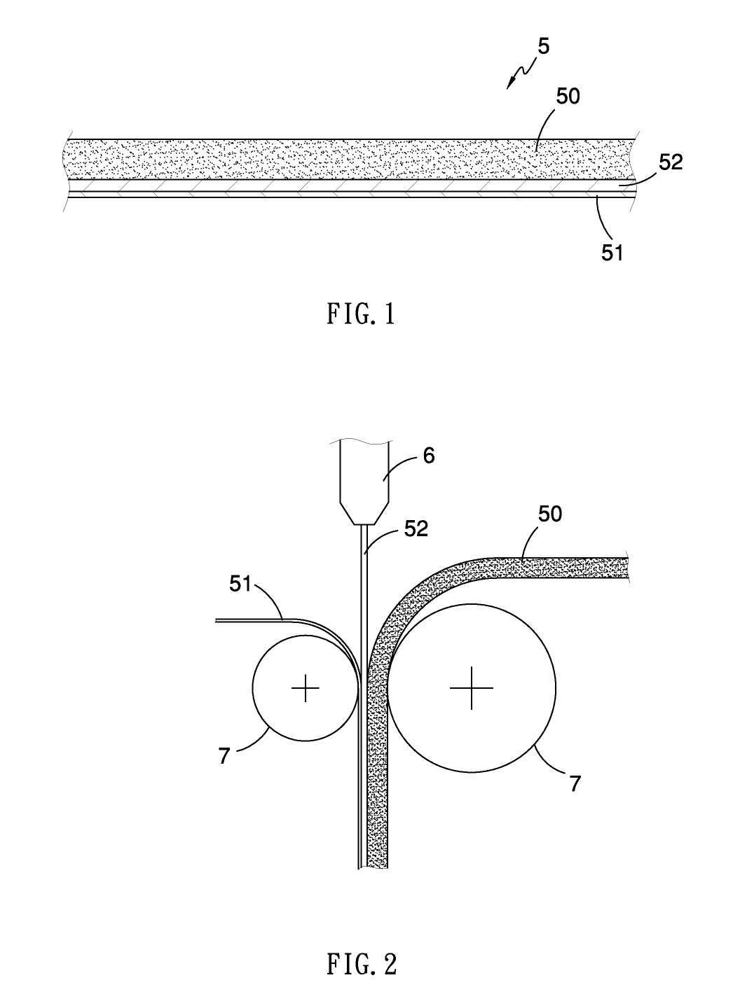

FIG. 1 is a cross-sectional view, showing a laminated board of a preferred embodiment according to the present invention. The laminated board 5 includes a foam sheet or layer 50, a first plastic film 51 and a second plastic film 52.

Preferably, the first plastic film 51 is advantageously designed to provide the laminated board 5 with an appealing and identifiable appearance. In another example, the first plastic film 51 may also provides the laminated board 5 with other purposes, such as, but not limited to, a textured surface or grip surface or even a slippery surface. Therefore, the first plastic film 51, in the present embodiment, has a pattern printed on the inside or outside surface of the first plastic film 51, or even between two layers of film that comprise the first plastic film 51. In addition, the first plastic film 51 may be colored and may only be a colored film without a pattern.

Referring now to FIG. 2, a preferred method for making the laminated board is illustrated. The preferred method includes making or otherwise providing the foam layer 50 and the first plastic film 51 of the preferred embodiment. The second plastic film 52 is molten and extruded through an extruder 6. The molten second plastic film 52 is extruded between the first plastic film 51 and the foam layer 50 through the thrust of two pressure rolls 7. Thereafter, the laminated board 5 (FIG. 1) is finished after cooling the laminated layer and films.

As described above, the second plastic film 52 is interposed between the foam layer 50 and the first plastic film 51 by means of extrusion lamination to combine them together. Different from and not requiring general adhesive materials; the second plastic film 52 with a proper thickness is adapted to not only combine the foam layer 50 with the first plastic film 51, but also allow the laminated board (FIG. 1) to have a greater structural strength to increase wear resistance.

To achieve a better bonding effect, the layer components of the laminated board 5 (50, 51 and 52) are selected from a similar or generally identical materials. For example, the foam layer 50 is made of a polyethylene foaming material, and the materials of the first and second plastic films 51, 52 are preferably a polyethylene, Oriented polypropylene (OPP), Polycarbonate (PC), a Surlyn® resin made by Dupont, or the like.

Preferably, the first plastic film 51 has a thickness in the range of between about 0.07 mm and 0.2 mm, the second plastic film has a thickness in the range of between about 0.1 mm and 0.8 mm, and the thickness of the second plastic film 52 is preferably allowed to be greater than the thickness of the first plastic film 51, thereby ensuring the combination of the foam layer 50 with the first plastic film 51 is complete and durable, and preventing peeling or even delaminating of the layer components from one another.

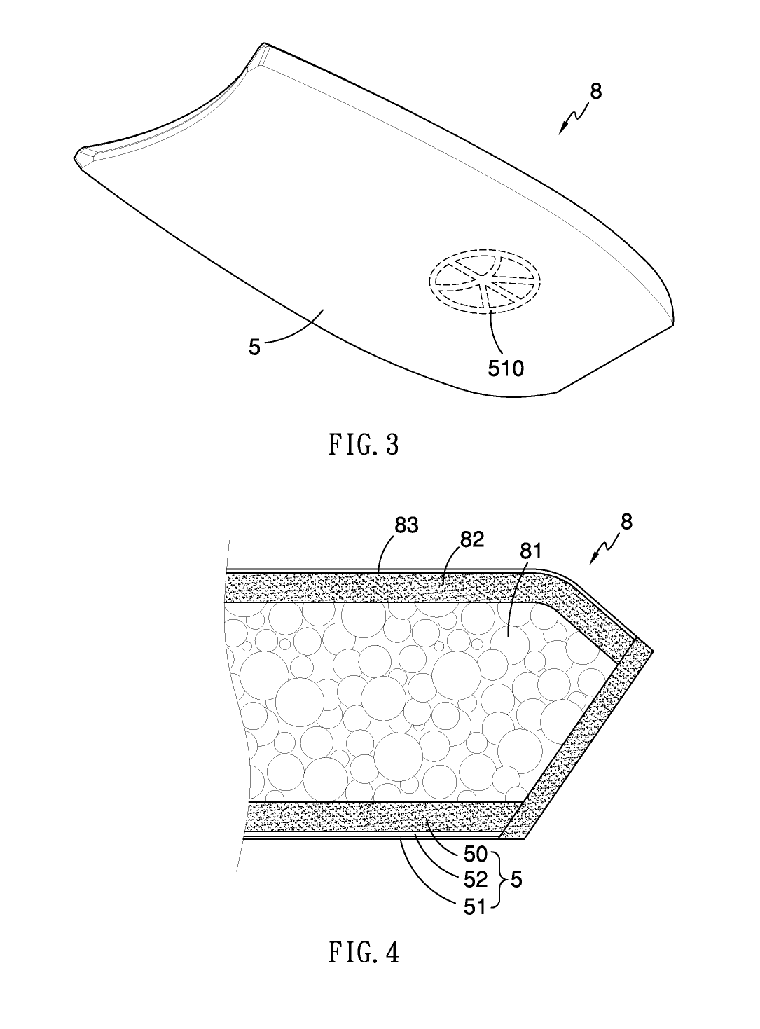

FIGS. 3 and 4 show a foam product 8 to which the laminated board of the present invention is applied. Besides the described laminated board 5, the foam product 8 further includes a foam core 81, another foam layer 82 heat laminated to the top surface of the foam core 81, and a third plastic film 83 heat laminated to the top surface of the foam layer 82. Similarly, the third plastic film 83 has a pattern or color to allow the foam product 8 to be more appealing and identifiable as well as to provide a preferred surface texture or durability. Moreover, the foam layer 50 of the laminated board 5 may be attached to the bottom surface of the foam core 81, and serves as a bottom skin of the foam core 81.

Preferably, the foam layer 50 has a density in the range of between about 1.5 pcf and 8 pcf and a thickness in the range of between about 2 mm and 5 mm. A pattern 510 of the first plastic film 51 of the laminated board 5 is visible from outside of the first plastic film 51, as shown in FIG. 3, allowing, among other advantageous, the foam product 8 to be more appealing and identifiable. In addition, the second plastic film 52 is not only adapted to combine the foam layer 50 with the first plastic film 51, but also increases the wear resistance and durability of the foam product 8.

Comparing with the conventional technology of the prior art, the present invention need not stack one foam sheet and two sheets of film one by one as the prior art does and needs only one extrusion laminating step to couple the three of laminate layers together to form the laminated board 5. Moreover, the foam product to which the laminated board is applied can advantageously be made cheaper and quicker.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A laminated board, comprising:
a foam layer;
a first plastic film; and
a second plastic film, interposed between the foam layer and the first plastic by means of extrusion lamination to combine the foam layer with the first plastic film.

2. The laminated board of claim 1, wherein the foam layer comprises a polyethylene foaming material.

3. The laminated board of claim 2, wherein the first plastic film comprises a polyethylene and the second plastic film comprises a polyethylene.

4. The laminated board of claim 1, wherein the first plastic film has a pattern.

5. The laminated board of claim 1, wherein the first plastic film has a color.

6. The laminated board of claim 5, wherein the second plastic film has a pattern.

7. The laminated board of claim 1, wherein the second plastic film has a thickness greater than that of the first plastic film.

8. A foam product, comprising:
a foam core having a top surface and a bottom surface;
a first foam layer, combined with the top surface of the foam core;
a second foam layer, combined with the bottom surface of the foam core;
a first plastic film; and
a second plastic film, interposed between the second foam layer and the first plastic film by means of extrusion lamination to combine the second foam layer with the first plastic film.

9. The foam product of claim 8, wherein the second foam layer is made of a polyethylene foaming material.

10. The foam product of claim 8, wherein the first plastic film comprises a polyethylene and the second plastic film comprises a polyethylene.

11. The foam product of claim 8, wherein the first plastic film has a pattern.

12. The foam product of claim 8, wherein the first plastic film has a color.

13. The foam product of claim 8, wherein the second plastic film has a thickness greater than that of the first plastic film.

14. The foam product of claim 8, further comprising a third plastic film, combined with a top surface of the first foam layer.

15. The foam product of claim 14, wherein the third plastic film further has a pattern.

16. A method for making a laminated board; comprising the following steps:
providing a foam layer and a first plastic film;
extruding out a molten second plastic film through an extruder; and
laminating the foam layer, the molten second plastic film and the first plastic film to have the second plastic film interposed between the foam layer and the first plastic film.

17. The method of claim 16, wherein the foam layer comprises a polyethylene foaming material.

18. The method of claim 17, wherein the first plastic film comprises a polyethylene and the second plastic film comprises a polyethylene.

19. The method of claim 16, wherein the second plastic film has a thickness greater than that of the first plastic film.

20. The method of claim 16, further comprising the step of embossing a pattern on the first plastic layer.
